(19) United States
(12) Patent Application Publication
(10) Pub. No.: US 2015/0122354 A1
(43) Pub. Date: May 7, 2015

(54) AUTOMATICALLY RESETTABLE PRESSURE RELIEF VALVE WITH MANUALLY RESETTABLE INDICATOR SYSTEM

(71) Applicants: RON MILLS, WALNUT, CA (US); DAVID M. MILLS, WALNUT, CA (US)

(72) Inventors: RON MILLS, WALNUT, CA (US); DAVID M. MILLS, WALNUT, CA (US)

(21) Appl. No.: 14/529,998

(22) Filed: Oct. 31, 2014

Related U.S. Application Data
(60) Provisional application No. 61/898,640, filed on Nov. 1, 2013.

(51) Int. Cl. F16K 37/00; F16K 17/04

(52) U.S. Cl. CPC F16K 37/0066; F16K 17/04
USPC 137/557

(57) ABSTRACT

A pressure relief valve for a pressurized fluid system in which a compression spring is used to seal a compression shaft in communication with a front bushing having a O-ring seal is provided. The relief valve automatically relieves overpressure conditions and automatically resets to a closed, leak proof after an overpressure event subsides. The compression shaft is also in communication with an indicator pin, which is pushed out of the body of the relief valve during an overpressure event, and remains pushed out until manually reset, thus indicating that an overpressure event has occurred, even after the overpressure event has subsided.

This application claims the benefit of U.S. Provisional Application No. U.S. 61/898,640, filed Nov. 1, 2013, the disclosure of which is incorporated by reference.

### TECHNICAL FIELD

This invention generally relates to an automatically resettable overpressure relief valve with an overpressure indicator system which once activated has to be manually reset even after the transient overpressure event has subsided.

### BACKGROUND

The present invention was designed to monitor and indicate transient overpressure events in a lubricating system. However, the present invention can be used in a variety of different fluid applications where it is necessary to provide overpressure relief and where it is desirable to note that a transient overpressure event has occurred even though the over-pressurization event has subsided.

Current overpressure indicators cease to indicate the occurrence of an over-pressurization event after the pressure has subsided to within normal pressure parameters and/or are of the type that have a destructive diaphragm of some sort which once displaced cannot be returned, either manually or automatically to a reset position. The disclosed resettable pressure relief indicator system continues to indicate the occurrence of an overpressure event, even after the system has returned to normal parameters.

There is a need for an automatically resetting pressure relief valve which provides for an indicator to indicate that an over-pressurization event has occurred, and that will continue to indicate that until such time as it is manually reset. This is particularly true for mechanical lubrication systems located for example, on booster pumps in pipelines where the location of the pumping station is remote or in mountainous terrain, not always accessible, and is difficult to maintain electronic monitoring on a 24/7 basis, such as, a trans-Alaska or trans-Canadian pipeline.

In such situations as a remotely located pumping station on a pipeline, it cannot be protected by use of a non-resettable over pressure relief valve as for example, if it were connected to a pressurized lubricating system for a pump, or it could easily drain all of the lubricating fluid from the pump, thereby causing the pump to seize. Purely automatically resettable pressure relief valves could be used, but there would be no way of knowing whether transient overpressure events had occurred, for example, when a transient overpressure event in the oil pressure in the lubricating system when a pump is turned on or turned off. Such transient events can cause significant damage to lubricating system seals and even the hardware in such events. Finally, there is a need to be able to contain any fluid that passes through the overpressure relief system to relieve the overpressure situation, so as not to pollute the environment or damage other equipment.

In such situations, some sort of a manual indicator that an overpressure event has occurred, even after the event has subsided, is desirable so as to alert operators performing routine maintenance on the system that such an event has occurred.

### SUMMARY OF THE DISCLOSURE

The overpressure relief valve of the present invention is generally formed of a tubular body having a central bore there through from an inlet end to a second end.

In the normal configuration, the second end has an aperture in which rests a piston pin indicator which is frictionally engaged with an indicator O-ring the one end adjacent to the second end of the relief valve. Formed integral with the piston indicator is piston indicator pin flange which rests against a pin extension shaft. The pin extension shaft resides within compression spring. Piston extension shaft has a flange formed integral therewith and is held in place between one end of the compression spring and a bearing surface on a rear retainer bushing. At the inlet end there is a fluid port formed integral with an attachment fitting which is sized and configured for attachment to an outlet port on the hydraulic or pressurized fluid system to which it is attached and is monitoring.

The fluid port is in direct fluid communication with an inlet chamber and is pressurized to system pressure. A compression shaft is contained and resides within a front retaining bushing and the rear retaining bushing. A leak proof hydraulic seal is provided by a front O-ring seal and a rear O-ring seal. The compression shaft is in direct abutment against the pin extension shaft flange at the second end and with the front end of the compression shaft residing within the front retaining bushing and is provided with a tapered end which is in contact with the pressurized fluid in the system being monitored. A hydraulic leak proof O-ring is provided on the front retaining bushing to provide a leak proof seal between the inlet chamber and an outlet chamber. An outlet port is formed integral within tubular body and in fluid communication with the outlet port so that when the outlet chamber contains overpressure fluid, it will freely flow through the outlet port. It is intended that the outlet port be affixed to some sort of conduit which will duct relieved fluid from the relief valve to a sump or back to a supply tank so as to prevent spills and/or a release direct to the environment.

When the relief valve is in an overpressure configuration the compression shaft is pushed by the over-pressurized fluid rearwardly toward the second end and in doing so pushes the rear pin extension shaft, which in turn pushes the piston pin indicator out through the aperture in the second end. The indicator pin O-ring maintains some frictional engagement with the indicator pin such that when the pressure transient subsides and the spring decompresses pushing the compression shaft back into frictional engagement with the front O-ring seal thereby creating a fluid tight connection, and the indicator pin will, because of the frictional engagement with the indicator pin O-ring, remain in its extended position even though the overpressure transient event has subsided.

A retainer snap ring is physically engaged within a slot on the compression shaft and prevents the compression shaft from extending any farther into the front retaining bushing than is necessary to fully engage the front O-ring seal. During an overpressure event the compression shaft is displaced rearwardly toward the second end and against the compression spring. This withdraws the compression shaft from full engagement with front the O-ring, thereby opening a fluid path around the compression shaft and between it and the front retaining bushing and around and/or through apertures within the retaining snap ring.

In this manner the piston pin indicator assembly will displace the indicator pin outwardly during an overpressure event.

Once the overpressure transient event has subsided, the compression spring will push against the pin extension shaft flange, which in turn will reset the compression shaft to its sealed position with the front O-ring seal, however the indicator pin will remain in its extended overpressure indicating position by reason of frictional engagement with indicator pin O-ring. It will remain in that position until someone manually resets the pin after the overpressure event has subsided.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 shows a sectional side view of the resettable overpressure relief valve in a normal operating position wherein pressure in the system being monitored remains within normal design parameters.

FIG. 2 is a sectional side view of the pressure relief valve in an overpressure configuration showing the indicator system activated.

FIG. 2a is an expanded, more detailed view of the compression shaft in an over-pressurized configuration showing the relief flow of over-pressurized fluid.

FIG. 3 is a sectional side view showing the configuration of the pressure relief valve after the overpressure event has subsided.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

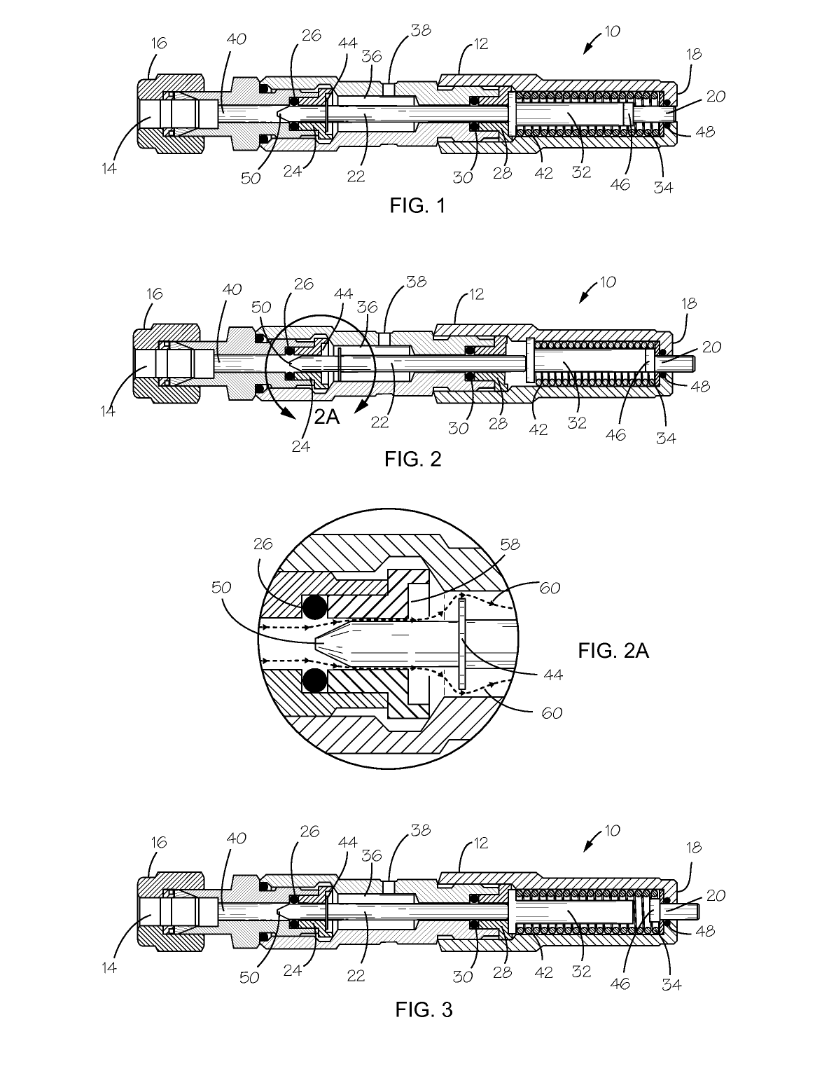

Referring to FIGS. 1 through 3 inclusive there is shown a sectional side view of the overpressure relief valve 10. It is generally formed of tubular body 12 having a central bore 14 there through from inlet 16 to second end 18.

In the normal configuration, second end 18 has an aperture in which rests piston pin indicator 20 which is frictionally engaged with indicator O-ring 48 at one end adjacent to the second end 18 of the relief valve 10. Formed integral with piston indicator 20 is piston indicator pin flange 46 which rests against pin extension shaft 32. Pin extension shaft 32 resides within compression spring 34. Piston extension shaft 32 has flange 42 formed integral therewith and is held in place between one end of compression spring 34 and a bearing surface on rear retainer bushing 28. At the inlet end 16 there is a fluid port formed integral with an attachment fitting which is sized and configured for attachment to an outlet port on the hydraulic or pressurized fluid system to which it is attached and is monitoring. While this is the preferred embodiment, it should be apparent that relief valve 10 does not have to be connected to an external port, but could be incorporated as an integral part of a piece of machinery, such as a pump body without changing the inventive concepts embodied herein.

The fluid port is in direct fluid communication with inlet chamber 40 and is pressurized to system pressure. Compression shaft 22 is contained and resides within front retaining bushing 24 and rear retaining bushing 28. A leak proof hydraulic seal is provided by front O-ring seal 26 and rear O-ring seal 30. Compression shaft 22 is in direct abutment against pin extension shaft flange 42 at the second end and with the front end of compression shaft 22 residing within front retaining bushing 24 and is provided with a tapered end 50 which is in contact with the pressurized fluid in the system being monitored. A hydraulic leak proof O-ring 26 is provided on front retaining bushing 24 to provide a leak proof seal between inlet chamber 40 and outlet chamber 36. Outlet port 38 is formed integral within tubular body 12 and in fluid communication with outlet port 38 so that when the outlet chamber 36 contains overpressure fluid, it will freely flow through outlet port 38. It is intended that outlet port 38 be affixed to some sort of conduit which will duct relieved fluid from the relief valve to a sump or back to a supply tank so as to prevent spills and/or a release direct to the environment.

FIGS. 2 and 2A show the relief valve 10 in an overpressure configuration. As can be seen, compression shaft 22 is pushed by the over-pressurized fluid rearwardly toward the second end and in doing so pushes the rear pin extension shaft 32, which in turn pushes the piston pin indicator 20 out through the aperture in second end 18. Indicator pin O-ring 48 maintains some frictional engagement with indicator pin 20 such that when the pressure transient subsides and the spring decompresses pushing compression shaft 22 back into frictional engagement with the front O-ring seal 26 thereby creating a fluid tight connection, the indicator pin will, because of the frictional engagement with indicator pin O-ring 48, remain in its extended position even though the overpressure transient event has subsided.

Retainer snap ring 44 is physically engaged within a slot (not shown) on compression shaft 22 and prevents compression shaft 22 from extending any farther into front retaining bushing 24 than is necessary to fully engage front O-ring seal 26 with bushing surface 58. As can be seen in FIGS. 2 and 2A, during an overpressure event compression shaft 22 is displaced rearwardly toward the second end and against the compression spring 34. This withdraws compression shaft 22 from full engagement with front O-ring 26, thereby opening a fluid path as shown by arrows 60 around compression shaft 22 and between it and front retaining bushing 24 and around and/or through apertures within retaining snap ring 44.

In this manner the piston pin indicator assembly will displace the indicator pin 20 outwardly during an overpressure event. The selection of the spring is made with system design pressure criteria in mind.

As shown in FIG. 3 once the overpressure transient event has subsided, compression spring 34 will push against pin extension shaft flange 42, which in turn will reset compression shaft 22 to its sealed position with front O-ring seal 26, however, indicator pin 20 will remain in its extended overpressure indicating position by reason of frictional engagement with indicator pin O-ring 48. It will remain in that position until someone manually resets the pin after the overpressure event has subsided.

In a second embodiment, a separate solenoid could be sized and fixed in a position to push the indicator pin 20 back in to its reset position, and controlled remotely, thus giving the operator an ability to remotely reset it.

While certain exemplary embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

I claim:

1. A resettable fluid over-pressurization indicator system configured to return over-pressurized fluid to a pressurized or unpressurized source of fluid regardless of the physical position of the source relative to the indicator, the resettable fluid over-pressurization indicator system comprising:
a generally tubular body comprising a first end configured to be in fluid communication with a pressurized system pipe and a second end configured to house a reciprocating indicator pin through a pin aperture therein, the tubular body further comprising a central bore comprising a vent aperture, between the first end and the second end, configured to permit the discharge of over-pressurized fluid from the pressurized system pipe;
a housing rotatably secured to the exterior of the generally tubular body, the housing enclosing the vent aperture and in fluid communication with the vent aperture regardless of the rotatable position of the housing, the housing further comprising an outlet configured to be in fluid communication with the fluid source when in use; and
a piston pin indicator assembly configured to reside within the central bore, the piston assembly configured for actuation in response to over-pressurization of a fluid in the pressurized system pipe downstream from the fluid source, the piston pin assembly comprising a piston connected to a spring having a compression coefficient sufficiently low to compress in response to exposure of the spring to the over-pressurized fluid from the pressurized system pipe so as to actuate a resettable indicator pin to indicate the occurrence of over-pressurization of the pressurized pipe system even after the occurrence of the over-pressurization ceases until the pin is manually reset, but where the compression coefficient is sufficiently high to withstand compression by any back pressure from the source of fluid, the piston indicator assembly being configured to permit the indicator pin to be manually reset, such that the system provides visual indication of over-pressurization of the pressurized fluid without giving a false positive based upon over-pressurization of the fluid source.

2. The resettable fluid over-pressurization indicator system of claim 1 wherein the indicator pin is electronically connected to a sensor permitting the user to reset the pin remotely.
